(19) United States
(12) Patent Application Publication
(10) Pub. No.: US 2009/0174963 A1
(43) Pub. Date: Jul. 9, 2009

(54) TAPE-BASED DATA STORAGE SYSTEM AND HEAD ENABLING COMPOUNDED READING RATE

(76) Inventors: Jason Liang, Campbell, CA (US); Robert Glenn Biskeborn, Hollister, CA (US)

Correspondence Address: ZILKA-KOTAB, PC- IBM, P.O. BOX 721120, SAN JOSE, CA, 95172-1120, US

(21) Appl. No.: 11/969,041

(22) Filed: Jan. 3, 2008

(51) Int. Cl. G11B 5/584

(52) U.S. Cl. 360/77.12

(57) ABSTRACT

A tape-based data storage system according to one embodiment comprises a head having at least two modules, each of the modules having an array of readers and writers, wherein at least some of the writers in a first of the modules are aligned with at least some of the readers in a second of the modules in a direction parallel to a direction of tape travel relative to the head, wherein at least some of the readers in the first module are offset laterally from the readers in the second module in a direction perpendicular to the direction of tape travel relative to the head, such that in a first readback mode, the readers from the first and second modules simultaneously read unique tracks on a tape.

### FIELD OF THE INVENTION

The present invention relates to data storage systems, and more particularly, this invention relates to tape-based data storage systems.

### BACKGROUND OF THE INVENTION

Magnetic tape-based systems have been widely accepted in the computer industry as a cost-effective form of data storage. In a magnetic tape drive system, a magnetic tape containing a multiplicity of laterally positioned data tracks that extend along the length of the tape is drawn across a magnetic read/write transducer, referred to as a magnetic tape head. The magnetic tape heads can record and read data along the length of the magnetic tape surface as relative movement occurs between the head and the tape.

There is a continuous need for higher data transfer rates to and from the magnetic tape. This need is greater in a reading mode, when retrieving data from the magnetic tape. The data rate may be limited by magnetic tape speed, linear density, and a number of active read channels, etc. Currently, for a bidirectional tape head, when reading in the forward or reverse direction, only the readers on one module, usually on the trailing side, are used to read the data.

### SUMMARY OF THE INVENTION

A tape-based data storage system according to one embodiment comprises a head having at least two modules, each of the modules having an array of readers and writers, wherein at least some of the writers in a first of the modules are aligned with at least some of the readers in a second of the modules in a direction parallel to a direction of tape travel relative to the head, wherein at least some of the readers in the first module are offset laterally from the readers in the second module in a direction perpendicular to the direction of tape travel relative to the head, such that in a first readback mode, the readers from the first and second modules simultaneously read unique tracks on a tape.

A tape-based data storage system according to another embodiment comprises a head having at least two modules, each of the modules having an array of piggybacked readers and writers; wherein at least some of the writers in a first of the modules are aligned with at least some of the readers in a second of the modules in a direction parallel to a direction of tape travel relative to the head, wherein at least some of the writers in the second module are aligned with at least some of the readers in the first module in a direction parallel to the direction of tape travel relative to the head, wherein at least some of the readers in the first module are offset laterally from the readers in the second module in a direction perpendicular to the direction of tape travel relative to the head, such that in a first readback mode, the readers from the first and second modules simultaneously read unique tracks on a tape, wherein, during a write mode, the readers of the second module read data just written by the writers of the first module, wherein data is written to the tape both in a forward direction and in a backward direction, wherein in the first readback mode twice as many tracks are read in a single pass of the tape across the head as are written in a single pass of the tape across the head.

A tape-based data storage system according to one embodiment comprises a head having two arrays of piggybacked readers and writers; wherein at least some of the writers in a first of the arrays are aligned with at least some of the readers in a second of the arrays in a direction parallel to a direction of tape travel relative to the head, wherein at least some of the readers in the first array are offset laterally from the readers in the second array in a direction perpendicular to the direction of tape travel relative to the head, such that in a first readback mode, the readers from the first and second arrays simultaneously read unique tracks on a tape.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a schematic diagram of a simplified tape drive system according to one embodiment.

FIG. 2 illustrates a flat-lapped bi-directional, two-module magnetic tape head which may be implemented in the context of the present invention.

FIG. 3A is a partial tape bearing surface view of a magnetic tape head according to the prior art.

FIG. 3B is a partial tape bearing surface view of a magnetic tape head according to the prior art.

FIG. 4A is a partial tape bearing surface view of a magnetic tape head according to one embodiment of the present invention.

FIG. 4B is a partial tape bearing surface view of a magnetic tape head according to one embodiment of the present invention.

FIG. 4C is a partial tape bearing surface view of a magnetic tape head according to one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The following description discloses several preferred embodiments of tape-based storage systems, as well as operation and/or component parts thereof.

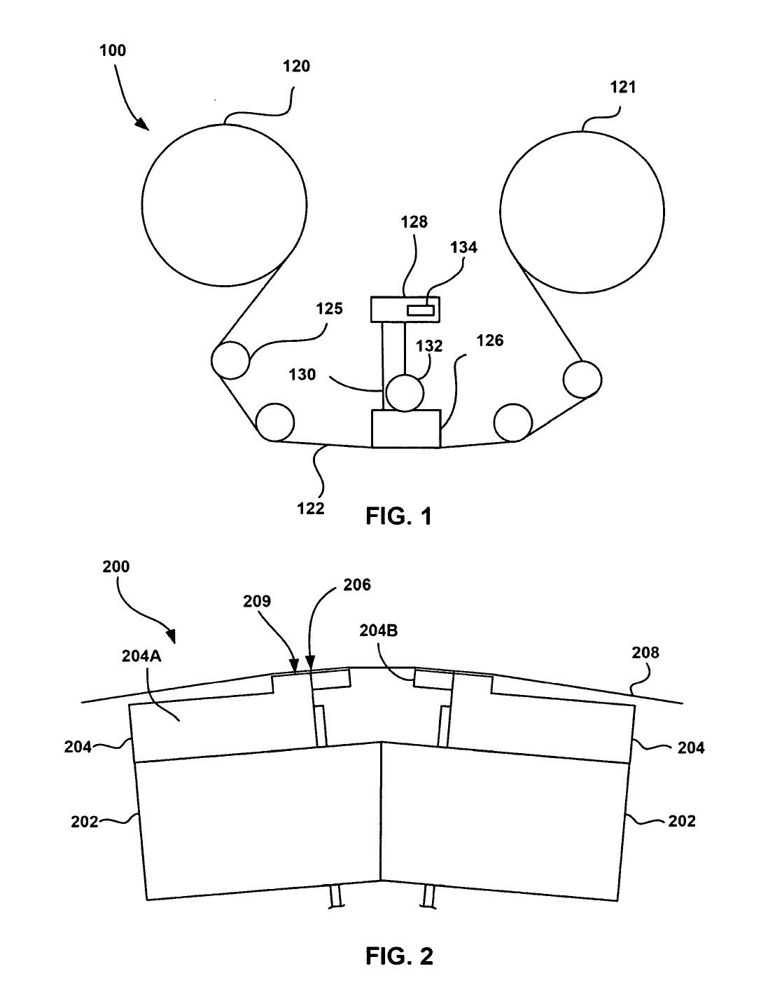

In one general embodiment, described generally with respect to FIGS. 1, 2 and 4A-C, a tape-based data storage system is provided which includes a head having at least two modules, each of the modules having an array of readers and writers. Additionally, at least some of the writers in a first of the modules are aligned with at least some of the readers in a second of the modules in a direction parallel to a direction of tape travel relative to the head. Furthermore, at least some of the readers in the first module are offset laterally from the readers in the second module in a direction perpendicular to the direction of tape travel relative to the head, such that in a first readback mode, the readers from the first and second modules simultaneously read unique tracks on a tape.

In another general embodiment, described generally with respect to FIGS. 1, 2 and 4A-C, a tape-based data storage system is provided which includes a head having at least two modules, each of the modules having an array of piggybacked readers and writers. Additionally, at least some of the writers in a first of the modules are aligned with at least some of the readers in a second of the modules in a direction parallel to a direction of tape travel relative to the head. Furthermore, at least some of the writers in the second module are aligned with at least some of the readers in the first module in a direction parallel to the direction of tape travel relative to the head. In addition, at least some of the readers in the first module are offset laterally from the readers in the second module in a direction perpendicular to the direction of tape travel relative to the head, such that in a first readback mode, the readers from the first and second modules simultaneously read unique tracks on a tape. Still yet, during a write mode, the readers of the second module read data just written by the writers of the first module. Further, data is written to the tape both in a forward direction and in a backward direction, and during the first readback mode twice as many tracks are read in a single pass of the tape across the head as are written in a single pass of the tape across the head.

In still another general embodiment, described generally with respect to FIGS. 1, 2 and 4A-C, a tape-based data storage system is provided which includes a head having two arrays of piggybacked readers and writers. Additionally, at least some of the writers in a first of the arrays are aligned with at least some of the readers in a second of the arrays in a direction parallel to a direction of tape travel relative to the head. Furthermore, at least some of the readers in the first array are offset laterally from the readers in the second array in a direction perpendicular to the direction of tape travel relative to the head, such that in a first readback mode, the readers from the first and second arrays simultaneously read unique tracks on a tape.

FIG. 1 illustrates a simplified tape drive 100 of a tape-based data storage system, which may be employed in the context of the present invention. While one specific implementation of a tape drive is shown in FIG. 1, it should be noted that the embodiments described herein may be implemented in the context of any type of tape drive system.

As shown, a tape supply cartridge 120 and a take-up reel 121 are provided to support a tape 122. One or more of the reels may form part of a removable cassette and are not necessarily part of the system 100. The tape drive, such as that illustrated in FIG. 1, may further include drive motor(s) to drive the tape supply cartridge 120 and the take-up reel 121 to move the tape 122 over a tape head 126 of any type.

Rollers 125 guide the tape 122 across the tape head 126. Such tape head 126 is in turn coupled to a controller assembly 128 via a cable 130. The controller 128 typically controls head functions such as servo following, writing, reading, etc. The cable 130 may include read/write circuits to transmit data to the head 126 to be recorded on the tape 122 and to receive data read by the head 126 from the tape 122. An actuator 132 controls position of the head 126 relative to the tape 122.

An interface may also be provided for communication between the tape drive and a host (integral or external) to send and receive the data and for controlling the operation of the tape drive and communicating the status of the tape drive to the host, all as will be understood by those of skill in the art.

By way of example, FIG. 2 illustrates a flat-lapped bi-directional, two-module magnetic tape head 200 which may be implemented in the context of the present invention. As shown, the head includes a pair of bases 202, each equipped with a module 204. The bases are typically “U-beams” that are adhesively coupled together. Each module 204 includes a substrate 204A and a closure 204B with channels comprising readers and/or writers 206 situated therebetween. In use, a tape 208 is moved over the modules 204 along a tape bearing surface 209 in the manner shown for reading and writing data on the tape 208 using the readers and writers 206.

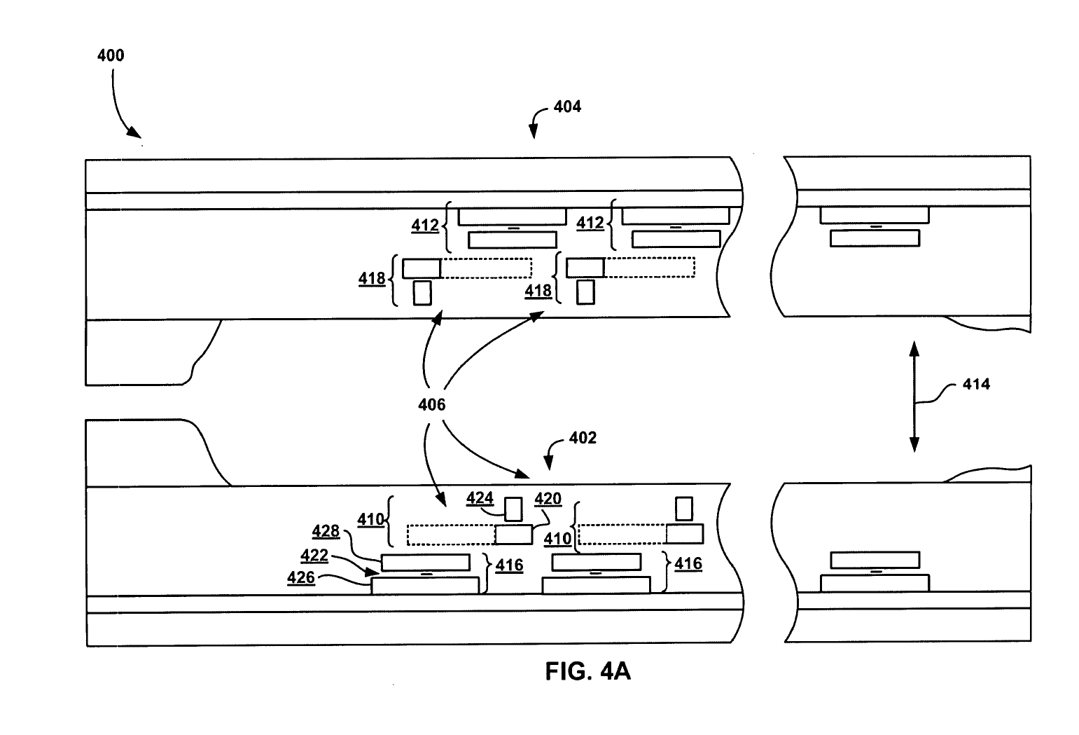

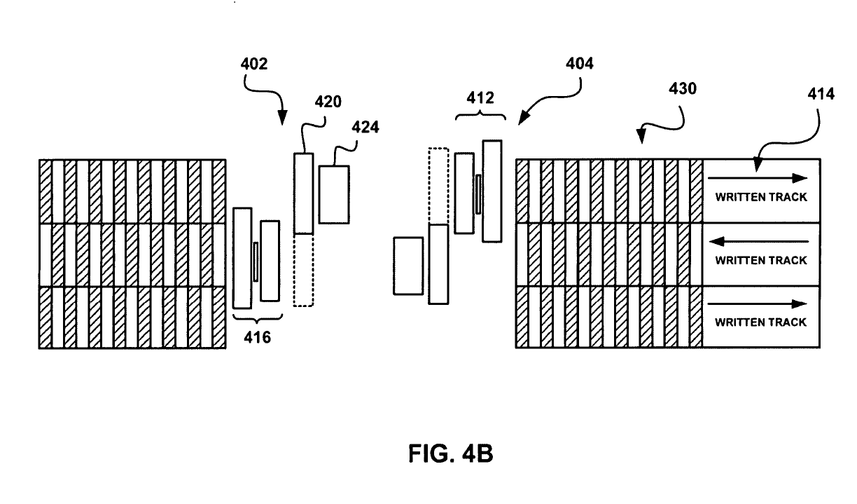

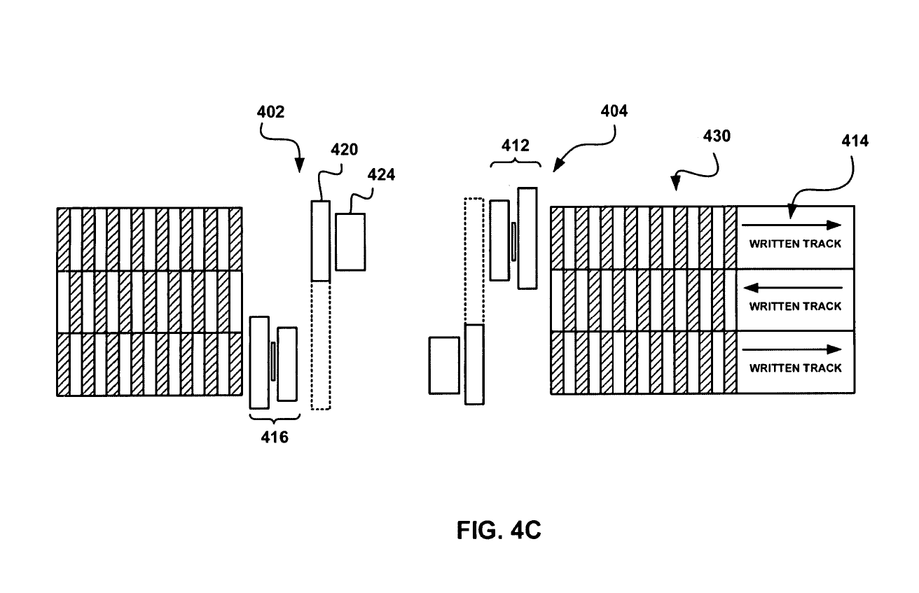

While arrays of transducers comprising readers and writers are preferably arranged in a piggyback configuration as shown in FIGS. 4A-B, the readers and writers may also be arranged in an interleaved configuration with the readers and writers on a given module being generally laterally aligned along a line. Alternatively, each array of transducers may be readers or writers only. Any of these arrays may contain one or more servo readers. Further, the head in some embodiments is a unitary structure rather than formed of two independent but coupled together modules.

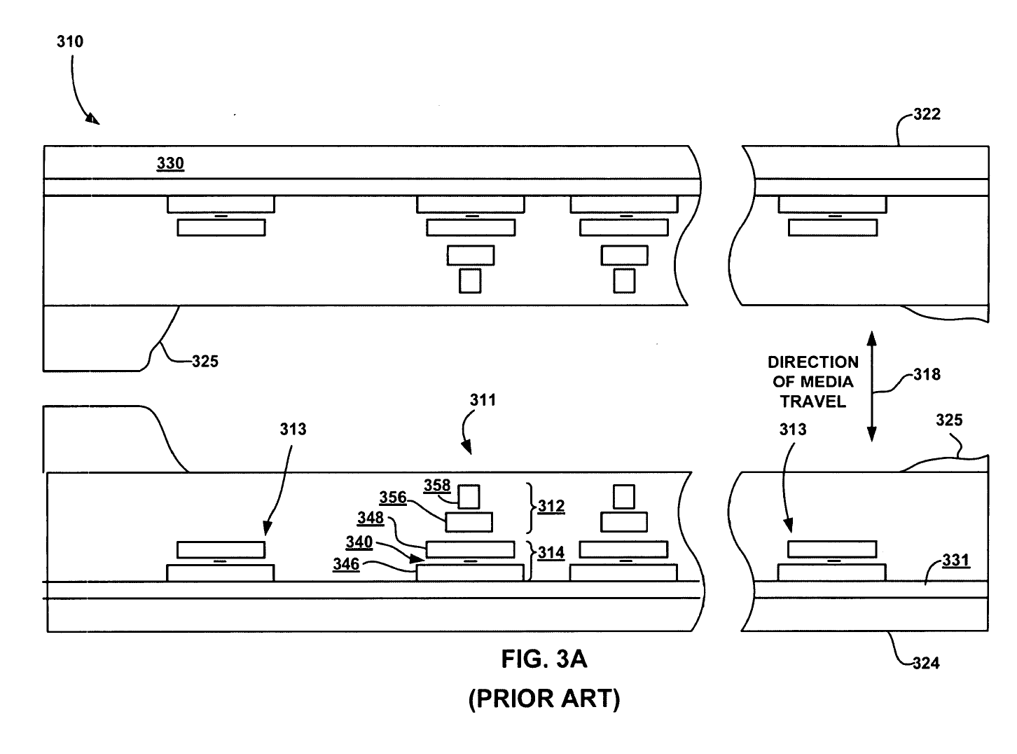

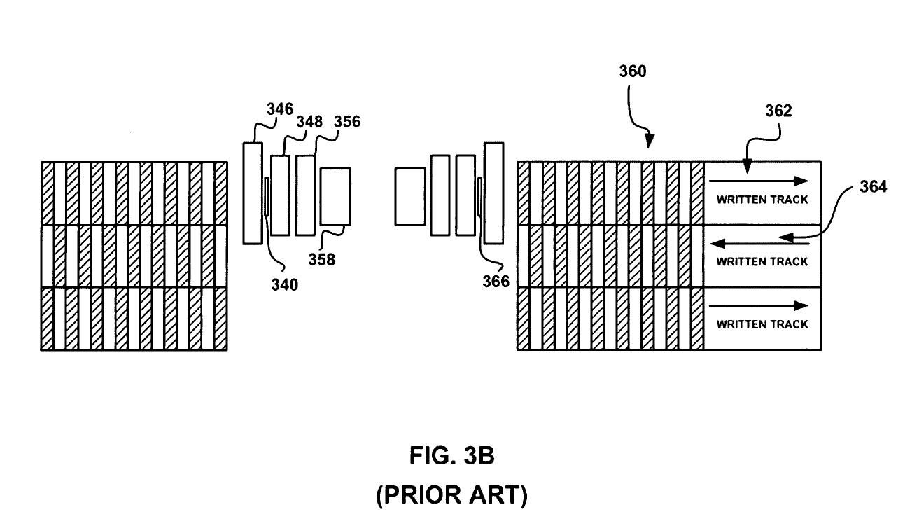

FIG. 3A shows a partial tape bearing surface (TBS) view of a magnetic tape head assembly 310 according to the prior art having a plurality of read/write (R/W) pairs in a piggyback configuration formed on a common substrate 330 and an optional electrically insulative layer 331. The writers, exemplified by the write head 312 and the readers, exemplified by the read head 314, are aligned parallel to a direction of travel of a tape medium thereacross to form a R/W pair, exemplified by the R/W pair 311.

Several R/W pairs 311 may be present, such as 8, 16, 32 pairs, etc. The R/W pairs 311 as shown are linearly aligned in a direction generally perpendicular to a direction of tape travel thereacross. However, the pairs may also be aligned diagonally, etc. Servo readers 313 are positioned on the outside of the array of R/W pairs, the function of which is well known.

Generally, the magnetic tape medium moves in either a forward or reverse direction as indicated by arrow 318. The magnetic tape medium and head assembly 310 operate in a transducing relationship in the manner well-known in the art. The piggybacked MR head assembly 310 includes two thin-film modules 322 and 324 of generally identical construction.

Modules 322 and 324 are joined together with a space or gap present between closures 325 thereof (partially shown) to form a single physical unit to provide read-while-write capability by activating the writer of the leading module and reader of the trailing module aligned with the writer of the leading module parallel to the direction of tape travel relative thereto. When a module 322, 324 of a piggyback head 310 is constructed, layers are formed on an electrically conductive substrate 330, e.g., of AlTiC, in generally the following order for the R/W pairs 311: an insulating layer 331, a first shield 346 typically of an iron alloy such as NiFe (permalloy), CZT or Al—Fe—Si (Sendust), a sensor 340 for sensing a data track on a magnetic medium, a second shield 348 typically of a nickel-iron alloy (e.g., 80/20 Permalloy), first and second writer pole tips 356, 358, and a coil (not shown).

The first and second writer poles 356, 358 may be fabricated from high magnetic moment materials such as 45/55 NiFe. Note that these materials are provided by way of example only, and other materials may be used. Additional layers such as insulation between the shields and/or pole tips and an insulation layer surrounding the sensor may be present. Illustrative materials for the insulation include alumina and other oxides, insulative polymers, etc.

FIG. 3B shows a partial tape bearing surface view of a magnetic tape head according to the prior art. As shown, a first shield 346, a first sensor 340 for sensing a data track on a magnetic medium 360, a second shield 348, and a first and second writer pole tips 356, 358 are provided. In operation, a particular data track on the magnetic tape 360 is written in a first direction 362 by a first set of writers and confirmed by a first set readers, then the head is shifted laterally by a predetermined amount (1 data band in this example) and data is written in a second direction 364 by a second set of writers and confined a second set of readers.

During a read operation, the magnetic tape is read either by sensor 340 or by sensor 66 in the first or second directions 362, 364. Thus, for example, the first sensor 340 does not operate when the second sensor 366 reads the tape 360 in the first direction 362. Similarly, the second sensor 366 does not operate when the first sensor 340 reads the tape 360 in the second direction 364.

FIG. 4A is a partial tape bearing surface view of a magnetic tape head according to one embodiment of the present invention. As shown, a tape-based data storage system 400 is provided, including a head having at least two modules 402 and 404, each of the modules 402 and 404 having an array of readers and writers 406. In use, writers 410 in a first of the modules 402 are aligned with the readers 412 in a second of the modules 404 in a direction parallel to a direction of tape travel 414 relative to the head.

As shown further, the readers 416 in the first module 402 are offset laterally from the readers 412 in the second module 404 in a direction perpendicular to the direction of tape travel 414 relative to the head, such that in a first readback mode, the readers from the first and second modules 402 and 404 simultaneously read unique tracks on a tape.

In one embodiment, during a write mode, the readers 412 of the second module 404 read data just written by the writers 410 of the first module 402. For example, as data is written to the tape by the writers 410 of the first module 402 the readers 412 of the second (trailing) module 404 may immediately read the data. In one embodiment, at least some of the writers 418 in the second module 404 may be aligned with at least some of the readers 416 in the first module 402 in a direction parallel to the direction of tape travel 414 relative to the head. As an option, some of the writers 418 in the second module 404 may be aligned with some of the writers 410 in the first module 402 in a direction parallel to the direction of tape travel 414 relative to the head.

In one embodiment, a pole (e.g. pole 420, etc.) of each writer may extend along an extent of a sensor of a reader closest thereto in a direction perpendicular to the direction of tape travel relative to the head. As an option, at least one pole 420 of a writer 410 may extend along an extent of a sensor 422 of a reader 416 closest thereto in a direction perpendicular to the direction of tape travel 414 relative to the head. In one embodiment, the pole to be extended may be the wider pole of two poles (e.g. poles 420 and 424). The narrower of the two poles remains narrow to ensure a narrow track width.

In one embodiment, the poles 420 and 424 may be constructed of a hard material (e.g., NiFe). In this case, extending the poles 420 and 424 along the width of the sensor (as shown in dashed lines in FIG. 4A) and/or shields 426, 428 may further protect the reader or portions thereof from wear. Of course, extending the poles 420 and 424 is merely exemplary and should not be construed as limiting in any matter. In other embodiments, the poles 420 and 424 may be any desirable size, e.g., having typical widths as used in the industry, wider than the shields of the adjacent reader, etc.

In one exemplary embodiment, data may be written to the tape both in a forward direction and in a backward direction, as generally shown in FIG. 4B. In this case, twice as many tracks may be read in the first readback mode in a single pass of the tape across the head as are written in a single pass of the tape across the head. For example, sixteen readers of sixteen read/write pairs on each of two modules may simultaneously read thirty-two tracks simultaneously.

As an option, the data may be written such that, in the first readback mode, data signals from all of the active readers (e.g., from both modules) are combined into a single outgoing data stream. The data stream may be outgoing to a host system (e.g. computer, etc.), for example, but could also be outgoing to an onboard processor for preprocessing, data extraction, etc. Standard deconvolution techniques may be used to separate the data.

As another option, in the first readback mode, the data received from the readers of one of the modules may be stored, at least temporarily, in a buffer and processed separately from the data received from the readers of the other of the modules. In this case, the buffer may include any mechanism for storing data received from the readers, e.g., RAM, EEPROM, flash memory, rewritable memory, etc.

In yet another option, the host or controller may receive an independent data stream from each of the modules and process both concurrently.

In another option as shown in FIG. 4B, discussed in more detail below, a first set of readers may be reading data written in the forward direction and a second set of readers may be reading data written in the reverse direction even though the tape is moving in either the forward or reverse direction. Data that was written in the direction opposite the direction of tape motion can be stored in a buffer and deconvoluted to the proper reading direction. The data that was written in the proper direction of tape motion can also stored in a second buffer. The two sets of data can later be combined to form one continuous flow of data.

FIG. 4B is a partial tape bearing surface view of a magnetic tape head according to one embodiment of the present invention. As shown, the readers 416 in the first module 402 are offset laterally from the readers 412 in the second module 404 in a direction perpendicular to the direction of tape travel 414 relative to the head, such that in a first readback mode, the readers from the first and second modules 402 and 404 simultaneously read unique tracks on a tape 430.

In one embodiment, the readers 412 and 416 may be offset laterally by one track on the tape as shown in FIG. 4B. In another embodiment, shown in FIG. 4C, the readers 412 and 416 may be offset laterally by an even number of tracks on the tape 430. This allows the readers to read data tracks that were written in the same direction. In still another embodiment, the readers 412 and 416 may be offset laterally by an odd number of tracks on the tape 430. It should be noted that, in various embodiments, the readers 412 and 416 may be offset by any number of tracks on the tape 430, depending on design criteria and/or implementation goals.

Using this configuration, all sensors of a plurality of read/write pairs may be active and reading data. For example, sixteen readers of sixteen read/write pairs may read from thirty-two tracks simultaneously. In one embodiment, data may be written to the magnetic tape in such a way that the data from all thirty-two tracks may be easily combined. In another embodiment, the data from one set of tracks may be stored in a buffer and combined at a later time.

It should be noted that, in various embodiments, the head assembly described in the above embodiments is not limited to two individual modules. For example, in one embodiment, the head assembly may a continuous structure. Furthermore, as shown in FIG. 48, the poles may optionally be extended to various lengths, as discussed above (e.g. see poles 420 and 424). Of course, such extensions are purely optional and should not be construed as limiting.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A tape-based data storage system, comprising:
a head having at least two modules, each of the modules having an array of readers and writers;
wherein at least some of the writers in a first of the modules are aligned with at least some of the readers in a second of the modules in a direction parallel to a direction of tape travel relative to the head,
wherein at least some of the readers in the first module are offset laterally from the readers in the second module in a direction perpendicular to the direction of tape travel relative to the head, such that in a first readback mode, the readers from the first and second modules simultaneously read unique tracks on a tape,
wherein data is written to the tape both in a forward direction and in a backward direction, wherein in the first readback mode more tracks are read in a single pass of the tape across the head as are written in a single pass of the tape across the head.

2. A system as recited in claim 1, wherein, during a write mode, the readers of the second module read data just written by the writers of the first module.

3. A system as recited in claim 1, wherein at least some of the writers in the second module are aligned with at least some of the readers in the first module in a direction parallel to the direction of tape travel relative to the head.

4. A system as recited in claim 1, wherein the readers are offset laterally by one or more tracks on the tape.

5. A system as recited in claim 1, wherein the readers are offset laterally by an even number of tracks on the tape.

6. A system as recited in claim 1, wherein the readers are offset laterally by an odd number of tracks on the tape.

7. A system as recited in claim 1, wherein a pole of each writer extends along an extent of a sensor of a reader closest thereto in a direction perpendicular to the direction of tape travel relative to the head.

8. A tape-based data storage system, comprising:
a head having at least two modules, each of the modules having an array of readers and writers;
wherein at least some of the writers in a first of the modules are aligned with at least some of the readers in a second of the modules in a direction parallel to a direction of tape travel relative to the head,
wherein at least some of the readers in the first module are offset laterally from the readers in the second module in a direction perpendicular to the direction of tape travel relative to the head, such that in a first readback mode, the readers from the first and second modules simultaneously read unique tracks on a tape,
wherein data is written to the tape both in a forward direction and in a backward direction, wherein in the first readback mode twice as many tracks are read in a single pass of the tape across the head as are written in a single pass of the tape across the head.

9. A system as recited in claim 8, wherein the data is written such that, in the first readback mode, data signals from all of the active readers are combined into a single outgoing data stream.

10. A system as recited in claim 8, wherein, in the first readback mode, the data received from the readers of one of the modules is stored in a buffer and processed separately from the data received from the readers of the other of the modules.

11. A tape-based data storage system, comprising:
a head having at least two modules, each of the modules having an array of piggybacked readers and writers;
wherein at least some of the writers in a first of the modules are aligned with at least some of the readers in a second of the modules in a direction parallel to a direction of tape travel relative to the head,
wherein at least some of the writers in the second module are aligned with at least some of the readers in the first module in a direction parallel to the direction of tape travel relative to the head,
wherein at least some of the readers in the first module are offset laterally from the readers in the second module in a direction perpendicular to the direction of tape travel relative to the head, such that in a first readback mode, the readers from the first and second modules simultaneously read unique tracks on a tape,
wherein, during a write mode, the readers of the second module read data just written by the writers of the first module,
wherein data is written to the tape both in a forward direction and in a backward direction, wherein in the first readback mode twice as many tracks are read in a single pass of the tape across the head as are written in a single pass of the tape across the head.

12. A system as recited in claim 11, wherein the readers are offset laterally by an even number of tracks on the tape.

13. A system as recited in claim 11, wherein the readers are offset laterally by an odd number of tracks on the tape.

14. A system as recited in claim 11, wherein a pole of each writer extends along an extent of a sensor of a reader closest thereto in a direction perpendicular to the direction of tape travel relative to the head.

15. A system as recited in claim 11, wherein the data is written such that, in the first readback mode, data signals from all of the active readers are combined into a single outgoing data stream.

16. A system as recited in claim 11, wherein, in the first readback mode, the data received from the readers of one of the modules is stored in a buffer and processed separately from the data received from the readers of the other of the modules.

17. A tape-based data storage system, comprising:
a head having two arrays of piggybacked readers and writers;
wherein at least some of the writers in a first of the arrays are aligned with at least some of the readers in a second of the arrays in a direction parallel to a direction of tape travel relative to the head,
wherein at least some of the readers in the first array are offset laterally from the readers in the second array in a direction perpendicular to the direction of tape travel relative to the head, such that in a first readback mode, the readers from the first and second arrays simultaneously read unique tracks on a tape,
wherein data is written to the tape both in a forward direction and in a backward direction, wherein in the first readback mode more tracks are read in a single pass of the tape across the head as are written in a single pass of the tape across the head.

18. A tape-based data storage system, comprising:
a head havinig two arrays of piggybacked readers and writers:
wherein at least some of the writers in a first of the arrays are aligned with at least some of the readers in a second of the arrays in a direction parallel to a direction of tape travel relative to the head,
wherein at least some of the readers in the first array are offset laterally from the readers in the second array in a direction perpendicular to the direction of tape travel relative to the head, such that in a first readback mode, the readers from the first and second arrays simultaneously read unique tracks on a tape,
wherein data is written to the tape both in a forward direction and in a backward direction, wherein in the first readback mode twice as many tracks are read in a single pass of the tape across the head as are written in a single pass of the tape across the head.

19. A system as recited in claim 18, wherein the data is written such that, in the first readback mode, data signals from all of the active readers are combined into a single outgoing data stream.

20. A system as recited in claim 18, wherein, in the first readback mode, the data received from the readers of one of the modules is stored in a buffer and processed separately from the data received from the readers of the other of the modules.
